(19) United States
(12) Patent Application Publication
(10) Pub. No.: US 2008/0243569 A1
(43) Pub. Date: Oct. 2, 2008

(54) AUTOMATED LOAN SYSTEM AND METHOD

(76) Inventor: Michael Shane Hadden, Stamford, CT (US)

Correspondence Address: CHRISTINE JOHNSON ESQ., 151 Trenton Rd., Fairless Hills, PA, 19030, US

(21) Appl. No.: 11/957,300

(22) Filed: Dec. 14, 2007

Related U.S. Application Data
(60) Provisional application No. 60/921,322, filed on Apr. 2, 2007.

(51) Int. Cl. G06Q 40/00; G06Q 30/00; G06Q 10/00

(52) U.S. Cl. 705/7; 705/35; 705/38; 705/39; 705/14

(57) ABSTRACT

The invention provides an automated system and method for providing a loan to a consumer. A loan request is received from a borrower. In response to receiving the loan request, non loan revenue associated with the borrower is determined. At least one loan term for a loan for the borrower is determined, based, at least in part, upon the non loan revenue. The method is carried out by analyzing information related to consumer purchases associated with the borrower. An amount of non loan revenue to be associated with the borrower is based, at least in part, on the information about consumer purchases.

### CROSS REFERENCE TO RELATED APPLICATIONS

This application claims the benefit of earlier filed provisional application 60/921,322 to Hadden, filed Apr. 2, 2007 and incorporated herein in its entirety by reference.

### FIELD OF THE INVENTION

The present invention relates generally to automated systems and methods for providing loans to borrowers.

### BACKGROUND OF THE INVENTION

In a conventional loan application processing system, a would-be borrower completes a loan application in which the borrower provides personal identification and other information, such as income, to a lender system. The lender's evaluation of the borrower's application is typically based in part on the information provided by the borrower and in part on information about the borrower obtained by the lender system. For example a credit check is typically performed by a lender system communicating with one or more credit reporting systems to obtain information related to the borrower's history of loan repayments. If the borrower's loan application is approved, the terms of the loan to the borrower are typically based solely on the lender system's determination of expected credit behavior of the borrower except when the loan is made by a merchant to purchase the merchant's products. These conventional systems and methods lack the ability to determine or account for the value of a consumer's non credit purchasing behavior in the lending process.

What are needed are improved loan origination systems and methods. For example systems and methods which enable a consumer to obtain a loan with terms that are based, at least in part, on potential, but not guaranteed, future spending are needed. Loan systems and methods that automatically adjust the terms of a loan over time based on non-credit behavior of the borrower are needed. Further needed are systems and methods that evaluate conventional loan application data as well as non credit related data to compute loan terms based, for example, on previous non-credit related behavior of the borrower. Further needed are systems and methods that enable consumers to leverage the value of their purchasing power to obtain loans on more favorable terms than would be offered to them based on evaluation of their credit quality alone.

### SUMMARY OF THE INVENTION

The invention provides systems and methods that automatically account for, and capture the value of consumers' purchasing decisions, including past and future purchasing decisions, to overcome the drawbacks associated with conventional automated loan systems, such as those recited above.

### DESCRIPTION OF THE DRAWING FIGURES

These and other objects, features and advantages of the invention will be apparent from a consideration of the following detailed description of the invention considered in conjunction with the drawing figures, in which:

FIG. 1 is a block diagram of a lender system and a seller system in a network configuration suitable for implementing embodiments of the invention.

FIG. 2 is a flow chart of a lending method according to an embodiment of the invention implemented using the system illustrated in FIG. 1.

FIG. 3 is a block diagram of a network including a redemption system configured in a network suitable for implementing embodiments of the invention.

FIG. 4 is a flow chart illustrating steps of a method for determining non loan revenue according to an embodiment of the invention.

FIG. 5 is a flow chart depicting steps of providing a loan to a borrower according to an embodiment of the invention.

FIG. 6 is a flowchart illustrating steps of a method for determining non loan revenue according to an embodiment of the invention.

FIG. 7 is a block diagram illustrating components of a system according to embodiments of the invention.

FIG. 8 is a flowchart illustrating steps of a method for providing a loan to account for non loan revenue according to an embodiment of the invention.

FIG. 9 is a flowchart illustrating steps of a method for calculating an interest rate to account for non loan revenue according to an embodiment of the invention.

FIG. 10 is a flowchart illustrating steps of a method for calculating a loan amount to account for non loan revenue according to an embodiment of the invention.

FIG. 11 is a flowchart illustrating steps of a method for automatically adjusting a loan payment schedule to account for non loan revenue according to an embodiment of the invention.

### DETAILED DESCRIPTION OF THE INVENTION

### Terms and Definitions

The following terms are used as defined herein.

Borrower: The term “borrower” is used herein to refer to any individual, group, institution or other natural or legal entity who receives a loan from a lender.

Loan: a sum of money provided to, or any extension of credit to a borrower under repayment terms agreed upon by a lender and a borrower.

Loan term: any condition of repayment of a loan including, but not limited to: principal amount, interest rate (fixed, flexible or variable), repayment schedule, number of installments, amount of an installment (whether fixed, flexible or variable), time duration of loan.

Lender: any person, group, agency or organization that extends credit or provides cash or goods to a borrower as a loan.

Sponsor: a person or agency that undertakes certain responsibilities in connection with a program. Examples of sponsors according to embodiments of the invention described herein include, but are not limited to, proponents, endorsers, advisers, underwriters, sureties, lenders, buyers of goods and services, sellers of goods and services and the like. According to some embodiments of the invention a sponsor is also a merchandiser. In some embodiments of the invention described herein a sponsor provides a commission, also referred to as an “award”, a “reward” or a “point” or “points” to one or more third parties in connection with sales of the sponsor's merchandise. A commission has a monetary value associated with it. In some embodiments of the invention a commission comprises at least a portion of “non loan revenue”.

Program: a plan or procedure by which a person or group of persons (i.e., participants) participate in an activity. According to embodiments of the invention described herein a sponsor undertakes certain responsibilities in connection with the program participants or with the program activity.

Advertiser: An individual, group or agency that calls public attention to products or services for sale or rent.

Affiliate: a person, group or agency connected or associated with a program, a sponsor or an advertiser. Examples of affiliates include employees of an entity comprising a program, sponsor, or advertiser, family members of employees of such entities, and third party vendors and other strategic partners of such entities, to name but a few.

Advertising revenue: any revenue derived from advertising a product or service in contrast with profit from actual sales of the product or service itself. Advertising revenue is derivable from Internet based advertising as well as non Internet advertising. Advertising revenue is typically, but not necessarily, paid based upon a number of advertising impressions including, but not limited to, click-through, ad views, hits, responses or other indications an advertisement has been viewed.

Merchant/Merchandiser: a person whose business is buying and selling goods for a profit. The term merchant according to embodiments of the invention refers to merchants engaged in wholesale trade and also to retail merchants and shopkeepers, including keepers of shops on the Internet. In some embodiments of the invention a merchandiser is also a sponsor.

Non Loan Revenue: revenue received by a lender that is associated with a borrower, but derived from a source other than the borrower's loan payments. For example, in one embodiment non loan revenue is derived from a borrower's purchase of at least one sponsored product. In another example embodiment a borrower comprises an entity and non loan revenue is derived from purchases of sponsored products made by individuals associated or affiliated with the borrower, e.g., family, employees of the entity, etc.

The invention provides automated systems and methods for providing loans to consumers. The system and method of the invention enables a lender to value (i.e., take into account) consumers' present and future purchase decisions when the lender makes a loan determination with respect to a consumer. According to various embodiments of the invention both past and future purchase decisions of a consumer, or a group of consumers, are assigned units of value referred to herein as “points”, “rewards” or “purchase power points”. In some embodiments of the invention the units of value are derived from commissions associated with sponsored products. Systems and methods of the invention operate to capture this value and convert the value to non loan revenue available to be leveraged by a borrower in obtaining a loan.

Methods and systems of embodiments of the invention are deployable to provide loans to consumers including loans selected from the group comprising: secured loans, corporate loans; business loans; loans to any borrower anywhere in the world; government loans; municipal loans; grants of money for future payment evidenced with notes, preferred shares, or otherwise. Loan terms such as the rate, maturity, pre-payment, payment timing, fixed/floating, etc. may vary according to various embodiments of the invention.

In one embodiment of the invention a purchaser system tracks non loan revenue associated with purchases of products by individual consumers. In some embodiments of the invention the purchaser system tracks points for individual consumers and for groups of consumers. For example, a system tracks purchases of consumers having a common demographic characteristic in one embodiment of the invention. Variations of purchase tracking systems of the invention make projections about future purchase decisions of a consumer or a consumer's demographic group. Points are accorded to individual consumers belonging to the tracked group based upon past and/or projected purchases of the group. Systems and methods of the invention relate points earned by a consumer to non loan revenue available for the consumer's benefit in taking out a loan in accordance with the methods and systems described herein.

Systems and methods of the invention enable a lender to account for these “purchase power” points in making loan determinations. Embodiments of the invention enable a consumer to apply points to offset risk to a lender if the lender makes a loan to the consumer. In some cases, a lender is enabled to provide a loan at a lower interest rate than would otherwise be offered to a particular consumer. The lower interest rate is due to calculations made by systems of the invention that account for the consumer's points. According to some embodiments of the invention a consumer is enabled to automatically apply points to make a loan payment for an outstanding loan. Because a point represents a portion of a purchase price reserved as a commission, a point represents actual revenue available for allocation by consumer to a designated recipient, for example, to a lender.

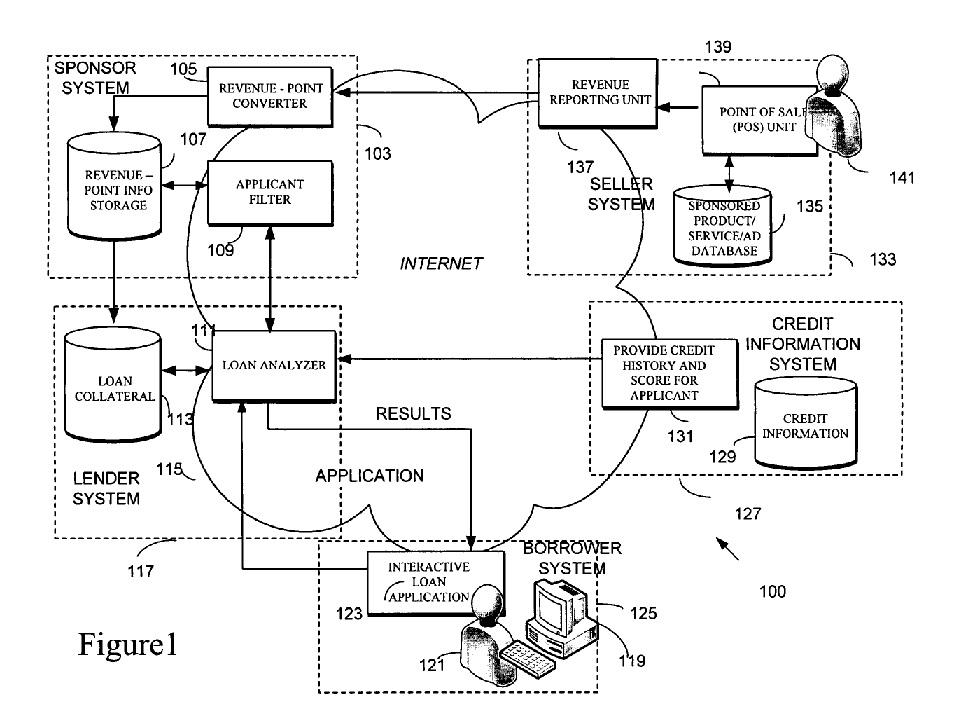

### FIG. 1

FIG. 1 illustrates a lender system 117 for providing a loan to a borrower according to an example embodiment of the invention. FIG. 1 illustrates lender system 117 in a context of a network 100 comprising a plurality of communicating nodes, e.g., seller system 133, sponsor system 103, credit information system 127, borrower system 125 and lender system 117. According to the embodiment illustrated in FIG. 1 lender system 117 communicates with borrower system 125, a credit reporting system 127, a seller system 133 and a sponsor system 103 via a wide area network, for example, the Internet.

Lender system 117 comprises a loan analyzer unit 111 and a loan collateral database 113. Database 113 stores and tracks non loan revenue and sponsored program point information related to sales and advertisements of sponsored products. Loan analyzer unit communicates with borrower system 125 via borrower interface unit 115 of lender system 117 to receive information comprising a loan application from a borrower 121. In some embodiments of the invention, loan analyzer 111 is further coupled to optional applicant filter 109 of sponsor system 103 to transmit and receive sponsored program participation information related to applicant 121. Examples of sponsored program information include, for example, an indication of whether an individual is a member of a sponsored program. Alternatively applicant filter 109 is configured to transmit and receive information related to an individual, or group of individuals who represent applicant 121. In that case applicant 121 need not be a sponsored program member to derive benefit from points earned, or predicted to be earned, by one or more individuals who are representative of the applicant.

Loan analyzer unit 111 is coupled to database 113 to search database 113 in accordance with criteria provided to applicant filter 109. According to one embodiment of the invention applicant filter criteria includes, but is not limited to applicant demographic characteristics such as age, income, residence, and the like. Loan analyzer unit 111 retrieves applicant information from database 107 in accordance with criteria provided to the applicant filter. Criteria are manually provided by an operator in one embodiment of the invention. In other embodiments criteria are automatically obtained from information provided by a borrower, for example, on a loan application via borrower system 125. In this embodiment of the invention,

In operation borrower interface unit 115 communicates with borrower system 125 to receive information comprising a loan application. Examples of information comprising a loan application include, but are not limited to personal information about a borrower, for example, age, income, marital status etc; an amount of credit or cash the borrower seeks, and other information typical of information used in making lending decisions. Information received from borrower system 125 is provided to loan analyzer 111.

In response to receiving information comprising a loan application, loan analyzer 111 communicates with a source of credit information, such as credit information system 127. Loan analyzer 111 receives credit information related to borrower 121, for example, a credit score and credit history. Examples of suitable credit information systems include credit reporting agencies as well as lender databases storing credit history and other information relevant to creditworthiness of borrower 121.

Conventional lender systems include systems configured to communicate with credit information systems to retrieve and evaluate a borrower's credit history information to determine whether a loan will be made to the borrower and on what terms. However, unlike conventional systems, loan analyzer 111 is further configured to communicate with a sponsor system 103 to implement embodiments of the invention. Sponsor system 103 includes an applicant filter 109 that enables loan analyzer 111 to query to a source of sponsored program revenue and point information associated with a borrower 121.

Sponsored program revenue and point information are provided to sponsor system 103 by any of a number of sources of sponsor program information. For example, a seller system 133 comprising a point of sale system such as a computerized cash register is configured to provide information related to sales of goods, including sponsored goods to buyers, e.g. buyer 141. Examples of information related to sales of sponsored goods include, but are not limited to, item identification for the good, a price of the good, and an indication of whether the good is a sponsored product among other types of information. If a good is a sponsored product, information related to a sale of the good includes an amount of commission associated with the sponsored product.

According to embodiments of the invention a sponsor of a good determines a price for the good. The price includes an amount to be allocated as a commission upon sale of the good. In some embodiments of the invention, at least a portion of a commission comprises a reward to a sponsored program member. In some embodiments of the invention at least a portion of the commission is represented as a point in the context of a sponsored program. In that manner each sponsored product sold to a buyer 141 generates a commission, or point. A revenue reporting system of seller system 133 provides information about the generated commissions and/or points to sponsor system 103, along with information about the buyer 141, if such buyer information is available.

In some embodiments of the invention a revenue/point converter 105 of sponsor system 103 operates to allocate a number of points to be awarded corresponding to an amount of revenue generated by earned commissions on sales of sponsored goods. The information about points and commission revenue is stored in a database 107 or other suitable memory of sponsor system 103. Information about this revenue for a specific borrower 121, or for an individual or group representative of a specific borrower 121, is provided to loan analyzer 111. Loan analyzer 111 includes this information as a factor in determining loan terms for borrower 121. Thus, automated loan systems of the invention including loan analyzer unit 111 are configured to receive and process both credit history information from conventional credit information sources and non loan revenue derived from sponsored program purchases associated with a borrower.

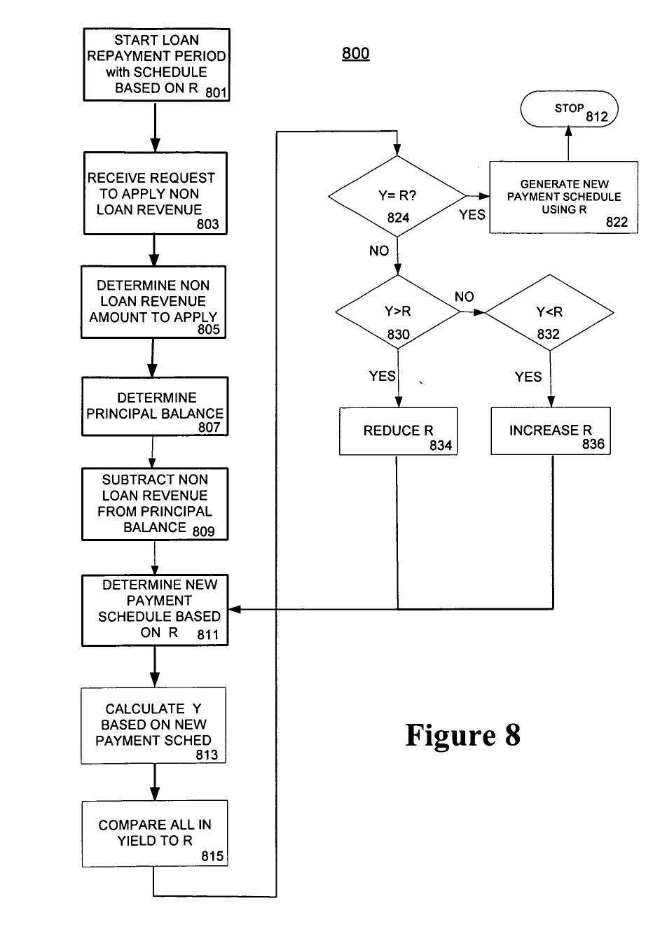

To accomplish this, loan analyzer 111 is coupled to a sponsor system 103. Sponsor system 103 includes a source of information about purchases of sponsored products by borrower 121. Loan analyzer 111 uses the information about purchases of borrower 121 as a factor in analyzing the loan application of the borrower. FIGS. 8-11 illustrated the operation of loan analyzer 111 according to embodiments of the invention. According to some embodiments of the invention loan analyzer 111 provides the results of the analysis to borrower 121 via borrower system 125.

FIG. 1 illustrates a single seller system 133 for purposes of illustration. However, it will be understood upon reading this specification that embodiments of the invention are configurable to accommodate any number of seller systems. Further a variety of seller systems are suitable for use in various embodiments of the invention. For example seller system 133 of FIG. 1 illustrates a point of sale (POS) unit 139. In embodiments of the invention wherein seller system 133 comprises an electronic cash register at a retail store, POR unit 139 comprises a Point of Sale (POS) system. The POS system records information related to sales of sponsored products and services to buyers, e.g., buyer 141. Similarly, for embodiments of the invention wherein a seller system 133 comprises an online merchant, POS unit 139 comprises, for example, an internet payment provider. Further embodiments of the invention encompass revenue derived from advertising sponsored products or services. In that case POS unit 139 comprises an online mechanism for monitoring and recording responses to advertisements, for example, “click-throughs”.

Loan analyzer 111 retrieves non loan revenue information, for example, commission or point information related to borrower 121. Loan application data interface unit 115 communicates with a loan system database 113. The non loan revenue, information stored in database 113 is provided to loan analyzer 111 to be factored in the determination of loan terms, for example, applied as collateral for a loan according to some embodiments of the invention. Loan system database 113 stores information provided by borrower 121 and, in some embodiments of the invention further stores information related to loan criteria, lender information and other information used for making loan decisions.

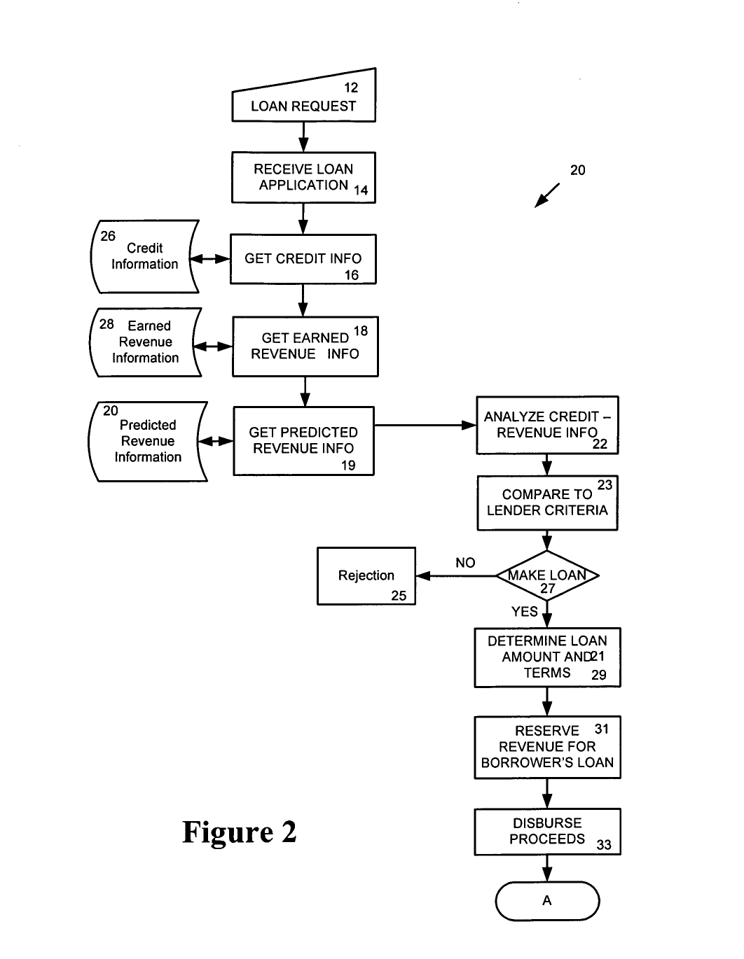

### FIG. 2

FIG. 2 is a flow chart illustrating a method 20 for providing a loan to a borrower according to an embodiment of the invention. According to one embodiment of the method the steps illustrated in FIG. 2 are carried out using the example system illustrated in FIG. 1 as described herein. In preparation for the method a potential borrower for example, a consumer who desires to make a purchase on credit, requests a loan at step 12. The consumer's loan request, for example in the form data obtained from a loan application received online, is received at step 14. At step 16 credit information related to the consumer is obtained from a source of credit information 26. Suitable sources of credit information include, for example, consumer credit reporting agencies such as Experion, TransUnion and Equifax. Other sources of credit information include a lender's own credit history files and other third party sources of information related to consumer credit.

At step 18, information about earned, non loan revenue associated with the borrower is obtained. According to various embodiments of the invention earned non loan revenue comprises at least one of commissions on sales of sponsored products and services and revenue derived from sponsored advertising. In one embodiment of the invention commissions on product sales refers to commissions earned on products actually sold in the past. Advertising revenue comprises revenue generated by advertising. Advertising includes Internet advertising and conventional advertising.

In another embodiment of the invention, points are automatically allocated to a buyer based on commissions and/or advertising revenue generated by the borrower. In one embodiment of the invention a sponsored program is provided wherein a point represents at least a portion of a commission associated with the purchase of a sponsored product or a sponsored service. In that case earned revenue information 28 includes point information. In the next step, which is optional in some embodiments of the invention, predicted revenue information related to the borrower is obtained from a source of predicted revenue information. Predicted revenue information includes information about revenue expected to be generated by a borrower, or a representative individual or group, in the future.

The credit information and the point and/or revenue information obtained at steps 18 and 19 are analyzed at step 22. In one embodiment of the invention the analysis step 22 is carried out to include a step 23 of comparing the borrower's information, for example at least one of the credit information obtained in step 16, the commission/point information obtained at steps 18 and 19 and personal data from the borrower's application, to lending criteria provided by a lender. At step 27 a determination is made whether or not to extend a loan offer to the borrower. The determination is based at least in part on the results of the analysis carried out in step 18.

If it is determined at step 27 that a loan cannot be made a rejection of the application takes place at step 25. If it is determined at step 23 that a loan could be made, loan terms are determined at step 29. Loan terms include at least one of interest rate, loan amount, late payment and prepayment terms, payment frequency, term, and payment method. Other typical loan terms may be determined at step 29. At step 31 at least a portion of earned revenue determined at step 18 is reserved by the lender for association with the borrower's loan. In some embodiments of the invention the earned revenue is associated with the loan so as to reduce the interest rate of the loan. In some embodiments of the invention the earned revenue is associated with the loan to increase the loan amount.

According to some embodiments of the invention, in addition to the earned revenue determined at step 18, predicted revenue determined at step 19 is reserved by the lender in step 31 for association with the borrower's loan. Those of ordinary skill in the art, upon reading this specification will then appreciate a variety of possible associations of earned and predicted revenue with a borrower's loan. All of these are intended to remain within the scope of the invention described herein.

In one optional embodiment of the invention, once the borrower accepts the loan terms, the borrower is enabled to receive at least a portion of the loan proceeds in cash. In this embodiment, a step of dispensing cash to the borrower is carried out in response to a borrower's election of an option to receive loan proceeds in cash. In one embodiment of the invention, the cash is dispensed to the borrower using an Automated Teller Machine (ATM).

Embodiments of the invention enable a consumer to use credits (i.e., “points”) for purposes other than obtaining a loan. For example, earned and expected points may be redeemed for cash, goods and services as will be described herein below.

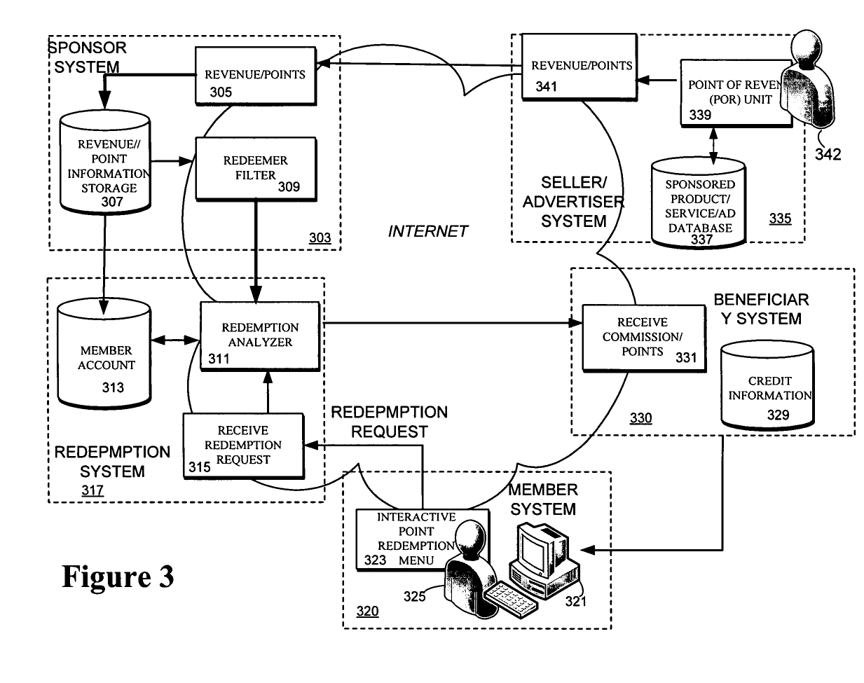

### FIG. 3

FIG. 3 illustrates an example point redemption system providing a graphical user interface (GUI) enabling a borrower to redeem credits earned through past, present or expected future purchases of sponsored goods or services. According to various embodiments of the invention points are redeemable for at least one of the following: cash, goods and services, loan payments, loan interest rate reduction, and trade of points in a market.

In the embodiment illustrated in FIG. 3 a program member 325 interacts with a redemption system 317 using a member system 321. In one embodiment of the invention member system 321 comprises a personal computer communicating with redemption system 317 via the Internet. In one variation the member system is suitably equipped with a display 329 for displaying an interactive redemption menu to member 325. Redemption menu 325 comprises member-selectable options for redeeming points. For example a member is provided with options including, redeem points for cash, redeem points for goods or services, apply points to make a payment on a loan, use points to lower a loan interest rate, and trade points in a market. It should be understood that a wide variety of point redemption options are suitable for implementing using the system and methods of the present invention. That is, the invention is not limited to particular point redemption options.

Once member 35 selects a redemption option from menu 323 the member selection is transmitted to redemption system 317. Redemption system 317 includes a request receiving unit 315. Receiving unit 317 determines an appropriate action to implement the selected option based on the received request. If an appropriate action relies on an analysis of a member's points, receiving unit 317 initiates a point analysis to determine an amount of points available to member 325 for redemption. Receiving unit 317 initiates this action by sending a signal to redemption analyzer 311. Redemption analyzer 311 is coupled to a source of member account information 313. Redemption analyzer 311 determines redemption constraints based on the amount of points available to member 325. For example, if member 325 selects an option to purchase an item based on points, redemption analyzer 317 determines if sufficient points are available to member 325 to purchase the item.

In one embodiment of the invention information about points available for redemption by member 325 is stored in a member account 313. According to one variation member account 313 is provided with point information by a sponsor system 303 via a revenue/point information storage unit 307. In another variation, sponsor system 303 is provided with point information by a seller system 335. For example, a seller system 335 comprises a point of sale terminal (POS) terminal 339. POS terminal 339 records purchase transaction information for item sold via seller system 335. Among the various items which may be sold by a seller using seller system 339 are sponsored products and services.

In one example embodiment information about sponsored products and services is stored in a database 337 of seller system 335. Examples of information stored in the seller system database 337 about sponsored products and services include item identification information, sponsor information, commission information, quantity information and the like. POS system 339 is configured for accessing sponsored product database 337 at the time of sale to determine if a sold item is a sponsored item. When a buyer 342 purchases a sponsored product or service POS system 339 records the transaction and provides information about the transaction to a commissions/points allocating unit 341. Unit 341 provides information about points and commissions to be reserved from a purchase price paid by buyer 342. If buyer 342 is a member of a sponsored program commissions/points allocator 341 associates the points with the program member purchasing the item. Commission/points allocator associates a reserved commission with a sponsor of the purchased item.

The information about number of points and reserved commission is communicated to sponsor system 303 via, for example, the Internet. The information is stored in a sponsor system database 307. The information in sponsor system database is available to be provided to redemption system 317. Therefore, information about points and commissions available for redemption by a member 325 is accessible to redemption analyzer 311. To obtain the information redemption system 317 communicates with sponsor system 303 via a communication link, for example, the Internet. Points and revenue associated with a member is stored in a member account 313 of redemption system 317.

An embodiment of system 300 enables a member to apply his or her available points, as represented in member account 313 in a variety of ways. In one example embodiment member system 320 enables member 320 to elect to designate a beneficiary 330 of at least a portion of points available to member 320. In such embodiments points are transferable from a member 325 to a beneficiary. Beneficiaries include other members, third parties, lenders, sellers. In one embodiment of the invention a beneficiary comprises a trader in a market. For example member 325 operates member system 321 such that redemption system 317 provides value corresponding to points to a beneficiary system 330. In one variation beneficiary system 330 is a personal computer system of a trader. In return for the points provided to beneficiary system 330, system 330 provides consideration to member 325. Examples of consideration include goods, services, financial products and a wide variety of other forms of consideration in exchange for which member 325 provides points to a trader.

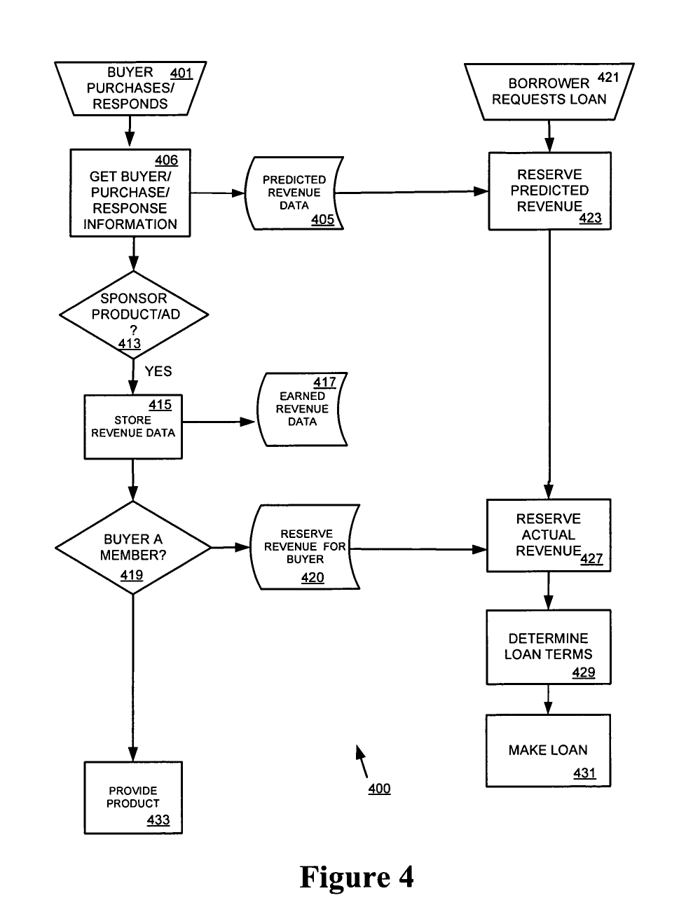

### FIG. 4

FIG. 4 is a flow chart illustrating the relationship of steps of a method for gathering information related to a purchase, to steps of a method for providing a loan to a borrower according to an embodiment of the invention.

A method for gathering information begins at step 401 when a buyer purchases an item or responds to an advertisement. Buyer purchase and response information is obtained at step 406. The buyer purchase and response information is obtained whenever possible and regardless of whether a buyer is a program member and regardless of whether a product, service or advertisement is sponsored. This data is stored at step 405.

At step 413 a determination is made whether the purchase or ad response is related to a sponsored product, service or advertisement. Various techniques are suitable for determining if a purchased good or service is related to a sponsored good or service. For example a purchased item identifier is compared to a list of identifiers corresponding to sponsored goods and services. In another variation items are labeled with identifiers that are recognizable to a POS system as identifying the item as a sponsored good or service. When a sponsored product or service is purchased, a portion of the purchase price is reserved as a commission in step 415. A variety of methods are suitable for use with the invention to determine a portion of a purchase price to be reserved as a commission. For example a percentage is determined at the POS by referencing a database storing information about sponsored goods or services including amount to be reserved as commission.

If the purchased item or response to an advertisement is not sponsored, the method stops. If the purchase or ad response is related to a sponsored product, service or advertisement data related to commission on the product or service, or revenue associated with the advertisement response is stored at 415. For example this information is stored in an earned revenue data information store at 417.

The method proceeds at step 419 by determining if the buyer of the sponsored product or service is a member of a sponsored program. If the buyer is not a member the commission information is stored in a database or other storage means for later retrieval and analysis and the process continues at step 433. If the buyer is a member of a sponsored program the commission/points generated by the purchase of a sponsored product are allocated to the buyer. At 420 the information is stored, for example in a database. The information stored at 415 is retrievable for later analysis. If the buyer is a member of a sponsored program, information about the commission or ad revenue is stored, and in that manner reserved for the buyer at step 420. In any case, the product, service or advertising message is provided to the buyer at step 433.

A method of providing a loan to a borrower commences at step 421 when a borrower requests a loan. At step 423 an amount of revenue expected to be generated by the borrower is determined by reference to data stored at 405. This revenue is associated with the borrower at step 423. At step 427 an amount of revenue actually generated by the borrower's purchases and advertisement responses is determined by reference to the reserved revenue information stored at 420. Based on the predicted and actual revenue associated with the borrower in the previous steps, loan terms are determined for the borrower at step 429. At step 431 a loan is made including the loan terms determined in the previous step 429.

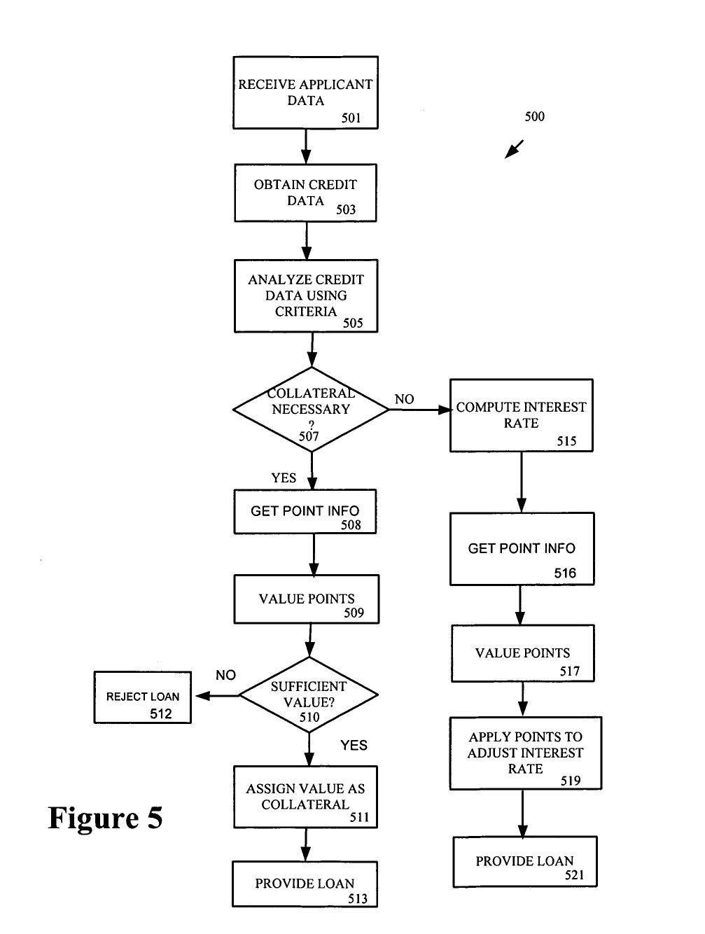

### FIG. 5

FIG. 5 illustrates steps of a method 500 for providing a loan to a loan applicant, i.e., borrower, according to one embodiment. The method commences when a borrower makes an application for a loan. The request is made using a loan application form which is an electronic loan application form in some variations of the invention. The data comprising the request is received at step 501. Data includes personal identification information of a borrower including for example, borrower name, address, social security number, age and other types of personal information usable for obtaining credit history information related to the borrower.

At step 503 credit information for the borrower is obtained. In various embodiments of the invention credit information is automatically obtained by accessing a commercially available source of consumer credit information such as Experion, TransUnion, Equifax and the like.

At step 505 the credit information obtained in step 504 is analyzed. In various embodiments of the invention analysis includes steps of comparing credit information to loan criteria. For example a lender may predetermine credit scores, or ranges of credit scores, to correspond with loan terms. Lower credit scores, for example, are associated with higher interest rates for a loan. In some cases a credit score in a low range indicates a loan will not be made unless collateral is made available to the lender to offset the lender's risk in making the loan.

In step 507 a determination is made if collateral is a condition of making the loan requested by the borrower. If collateral is to be a condition of making the loan the method proceeds at step 508 by obtaining point or revenue information related to the applicant. For example, a number of points available to the borrower for redemption are determined in step 508.

At step 509 at least a portion of the total points available to the borrower is valued. That is, a dollar value is associated with the borrower's points. A determination is made how much whether there is sufficient value associated with the borrower's available points such that the borrower may transfer available points to the lender as collateral for the loan, as indicated at step 510. If sufficient points are available to the borrower the points are assigned as collateral to the lender at 511. In that case the method proceeds by providing the loan to the borrower at step 513.

If step 507 is carried out and results in a determination that collateral is not to be a condition of providing a loan to a borrower, loan terms are determined in step 515. For example, an interest rate may be determined for the borrower based on the borrower's credit score obtained in step 503. At step 516 the borrowers point information is obtained. At step 517 a dollar value is associated with a number of points available to the borrower. In step 519 points are assigned to the lender in return for the lender providing more favorable terms for the loan than would be available without the points. For example points are applicable to adjust the interest rate computed in step 515 such that a more favorable interest rate is provided. According to embodiments of the invention points are usable to reduce interest rates and other loan terms for borrowers. Therefore, a loan is provided to the borrower at step 521 with more favorable terms, e.g., a lower interest rate, than would have been offered by the lender if the borrower had no points available.

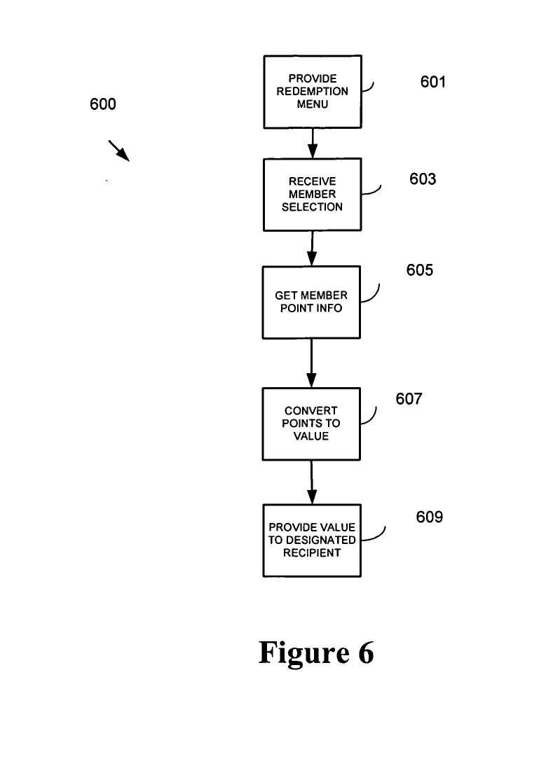

### FIG. 6

FIG. 6 illustrates steps suitable for carrying out analysis steps in the methods described herein according to one embodiment of the invention. It should be understood that the method illustrated in FIG. 6 represents one non-limiting example of a wide variety of analysis steps suitable to implement the methods of the invention described herein.

According to the example illustrated in FIG. 6 a menu is provided to a member at 601. The menu comprises an interactive list presenting available redemption options selectable by a member. The member selects a redemption option. The member selection is received at step 603. At step 605, information about points available to the requesting member is obtained. In one variation of the method the information about available points is obtained when a member logs onto a program website. In that case information about available points may be displayed to the member when the redemption menu is provided.

At step 607 points are converted to value. For example, an amount of commission reserved for purchases upon which points are based is determined. In that case a dollar value may result from the conversion step 607. In step 609 a recipient designated by the member is provided with the value associated with at least a portion of the member's points. Variations of the method permit designation of a wide variety of recipients including the member, a member other than the member, and other third parties. Examples of other third parties include lenders who may apply the value they receive to a loan account of the member. Other third parties include sellers of goods and services who will provide the goods and services to the member in exchange for the point value.

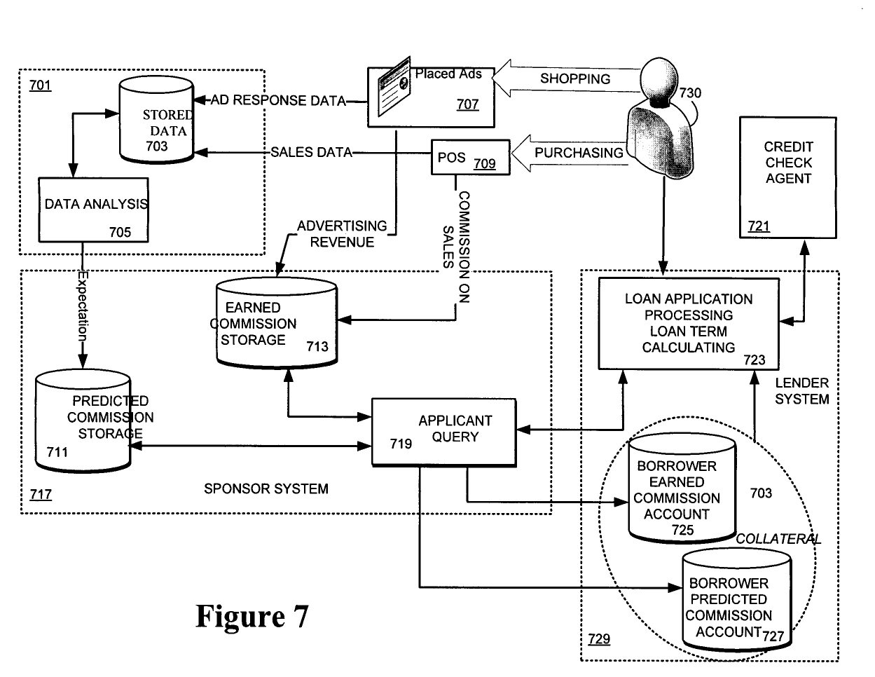

### FIG. 7

FIG. 7 is a block diagram illustrating interconnections of components of a network 700 configured to implement embodiments of the invention. System 700 is seen to comprise a sponsor system 717 coupled for communication with a lender system 729 and for communication with a data storage component 701. In some embodiments of the invention data collection and storage component 701 is co-located with sponsor system 717. In other embodiments of the invention data collection and storage component 701 is co-located with lender system 729. In alternative embodiments of the invention data collection and storage component 701 is implemented as a stand-alone component. For example, in some embodiments of the invention data collection and storage component 701 is provided by a third party system such as a third party data collection and storage agent.

Regardless of the provider of data collection and storage system 701, system 701 is configured to collect data related to sales of goods and services. For example data collection and storage system 701 is configured to communicate with at least one point of sale (POS) system 709. Data collection and storage system 701 receives information related to purchases of goods and services from POS system 709. Information related to purchases of goods and services includes at least one of: purchaser information such as name, address, telephone number, email address, etc; identification of items purchased, quantity and price of each item, time and date of purchase, method of payment, etc.

Further, according to embodiments of the invention data collection and storage system 701 receives information related to sponsorship of products and services from POS 709. Examples of sponsorship information include, but are not limited to, whether a purchased product or service is a sponsored product or service; identification of a sponsor of a purchased product or service, a commission associated with sale of a sponsored product or service; and identification of a purchaser as a member of a sponsored program.

Data collection and storage system 701 is further configured to communicate with at least one advertising impression recording system 707. Advertising impression recording system 707 provides data collection and storage system 701 with information relating to advertising of products and services offered for sale. According to embodiments of the invention advertising includes Internet advertising as well as advertising via conventional media such as print, radio and television advertising.

Advertising impression collection system 707 and POS system 709 are further configured for communication with sponsor system 717. Sponsor system 717 is provided with data representing advertising revenue earned by a sponsor related to advertising impressions for sponsored products. Sponsor system 717 is further provided with data representing commissions on sales of sponsored products and services.

Data collection and storage system 701 includes a data analysis unit 705 coupled to a memory unit 703. Memory unit 703 stores data provided by POS system 709 and advertising impression collection system 707. Data analysis unit 705 analyzes data stored in memory unit 703 to estimate expected future sales and advertising revenue based upon past sales and advertising revenue. [example algorithm]

Sponsor system 717 is seen to comprise at least one predicted-revenue account module 711 and at least one earned revenue account module 713. Predicted revenue account module 711 stores information related to expected future revenue from sales and advertising of sponsored products and services. Examples of information related to expected future revenue include, but are not limited to, personal identification of at least one individual associated with expected future advertising responses and sales of products and services; demographic and other aggregated information related to expected future purchasers of products and services; expected revenue associated with expected future purchases of products and services.

Earned revenue account module 713 is configured to receive, directly or indirectly, information related to earned commissions on sales from at least one POS system 709. Commissions are earned based on actual sales of sponsored products and services. Earned revenue account module 713 is further configured to receive, directly or indirectly, information related to advertising revenue provided by advertising impression collection module 707. Advertising revenue is generated by responses to advertisements for sponsored products and services.

Sponsor system 717 further comprises an applicant query module 719. Applicant query module 719 is configured to communicate with earned revenue account module 713 and predicted revenue account module 711. Applicant query module 719 queries and retrieves data from modules 713 and 711 in response to a signal from loan application processing module 723 of lender system 729.

Lender system 729 comprises loan application processing module 723 and borrower account modules 725 and 727. Borrower earned revenue account module 725 stores information related to revenue earned by a borrower, for example, a loan applicant 730. Earned revenue includes at least one of commissions on sales and advertising related revenue. Borrower predicted revenue account module 727 stores information related to revenue predicted to be earned by a borrower, for example, a loan applicant 730. Predicted revenue includes at least one of predicted commissions on sales and predicted advertising related revenue.

In one embodiment of the invention earned revenue account module 725 and predicted revenue account module 727 store information related to revenue associated with loan applicant 730 as an individual. According to some embodiments of the invention account modules 725 and 727 store information related to revenue earned and predicted to be earned by an individual, or group of individuals representative of loan applicant 730. Examples of individuals and groups of individuals representing a borrower or loan applicant 730 include individuals sharing at least one demographic attribute with borrower 730 such as age, income, gender, geographic residence, etc.

Loan application processing module 723 is configured to communicate with a loan applicant system to receive information related to a loan application. In operation, loan application processing module 723 receives a loan request from borrower 730. In response to receiving a loan request from borrower 730 loan application processing module 723 communicates with sponsor system 717 to automatically determine non loan revenue associated with loan applicant 730. Information about the non loan revenue is stored in accounts 703 and 729 of lender system 729. If a loan is to be offered to loan applicant 730, lender system 719 automatically calculates at least one loan term for the loan. The calculation is based, at least in part, on the non loan revenue information stored in account modules 725 and 727. A loan is then provided to loan applicant 730 including the loan term thus calculated.

According to one embodiment of the invention non loan revenue information to be associated with accounts 725 and 727 is provided by sponsor system 717 in response to a query generated by loan application processing module 723. The information retrieved by query module 719 is provided by data analysis module 705 of data analysis system 701. Data analysis module 705 analyzes information related to past purchases of loan applicant 730 stored in a memory 703 of system 701. The information is analyzed to determine an amount of non loan revenue associated with loan applicant 730. Loan application processing module 723 calculates at least one loan term for loan applicant 730 based, at least in part on the non loan revenue associated with the loan applicant.

### EXAMPLE 1

### Conventional System and Method: Interest Rate

Table 1 provides example interest rates for a conventional one year loan with level payments paid quarterly. According to typical calculations the interest rates are determined based upon the borrower's credit score. In some cases, a range of credit scores comprise a credit score class. In example Table 1 Class A represents credit scores in the top range. Borrowers in Class A represent the least risk to a lender. Class B represents credit scores in the middle range. Class C represents credit scores in the lower range. Borrowers in class C represent the highest risk of loan default to a lender.

It will be understood a wide variety of credit scoring systems and associated interest rates exist. Individual lenders may use various other classes, tiers and other credit score schemes to categorize or classify borrowers by risk of default. Regardless of the scheme used, and regardless of any particular interest rate associated with the scheme's categories, borrowers whose credit scores indicate a higher risk of default are offered loans with correspondingly higher interest rates. Borrowers whose credit scores indicate a lower risk of default are offered loans with correspondingly lower interest rates.

Another factor used in conventional loan term calculators is the amount of the loan. According to some lending methods and systems, higher interest rates are charged for higher loan amounts and lower interest rates are charged for lower loan amounts. The interest rate reflects the risk of loss to the lender if the borrower defaults on the loan.

TABLE I
EXAMPLE INTEREST RATES (Base Rate)
CONVENTIONAL LOAN TERM CALCULATOR

| | | Credit Score Class | | |
|---|---|---|---|---|
| | | A | B | C |
| Loan | <1,001 | 7% | 10% | 15% |
| Amount | 1,001-2,000 | 8% | 12% | 20% |
| | 2,001-5,000 | 9% | 14% | 30% |
| | 5,001-15,000 | 10% | 16% | 40% |
| | 15,001-25,000 | 11% | 18% | 50% |

### EXAMPLE 2

### Table 2

Table 2 illustrates an example loan payment schedule for an example loan made to an example borrower in accordance with conventional methods and systems. In the example illustrated in Table 2 a borrower has a credit score, according to the schema of Table 1 in the “B” category. In Example 2 the borrower requests a loan amount of one thousand dollars. However, other methods of selecting a loan amount are used. For example, in some cases a loan amount is determined by the lender for the borrower based on the borrower's credit score, income and other indicators of the borrower's ability and willingness to repay the loan. Based on the example rates set forth in Table 1 a borrower with a credit score in the B range may borrower one thousand dollars at an interest rate of ten percent.

TABLE II

| Quarter | Beg Principal | Payment | Interest | Ending Principal |
|---|---|---|---|---|
| 0 | | | | 1,000.00 |
| 1 | 1,000.00 | (265.82) | 25.00 | 759.18 |
| 2 | 759.18 | (265.82) | 18.98 | 512.34 |
| 3 | 512.34 | (265.82) | 12.81 | 259.33 |
| 4 | 259.33 | (265.82) | 6.48 | (0.00) |

All in yield = 10%

According to the repayment schedule illustrated in Table 2, the borrower is to make four equal payments, one payment in each calendar quarter. Each payment is $265.00. For the first payment $25.00 of the $265.00 payment is interest. For the second payment, $18.98 is interest. For the third payment $12.81 is interest. For the fourth and final payment $6.48 is interest. After the fourth payment the loan is repaid. The lender's All in Yield (Y) is 10%. The term “All in Yield” is used conventionally herein. For example, with reference to a loan the term “All in Yield” refers to the annualized percentage increase in the value of a lender's investment in a particular loan.

### EXAMPLE 3

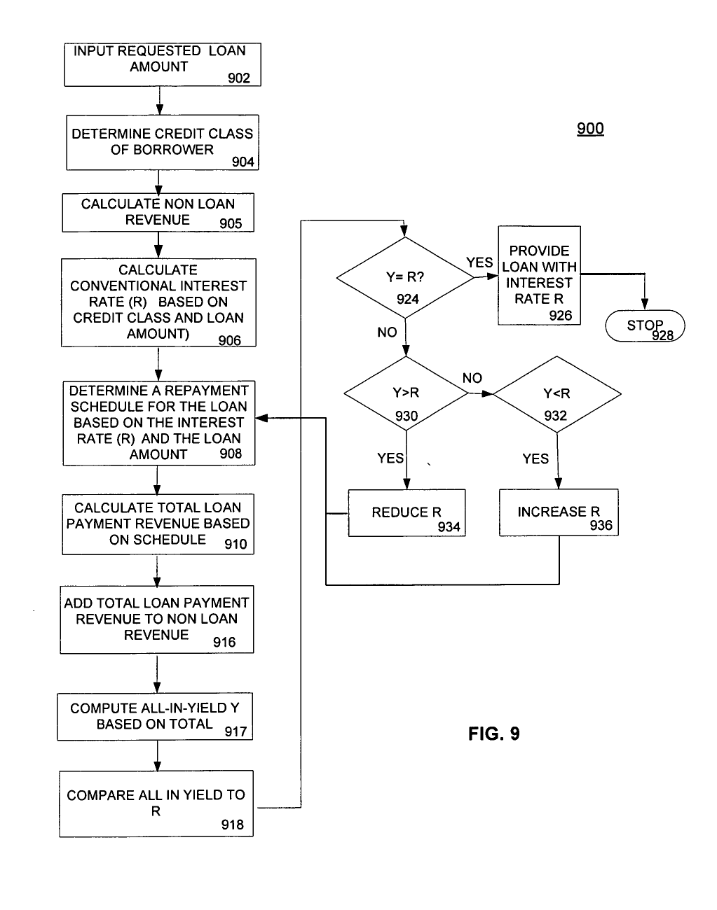

### Table 3, FIG. 9

In a scenario according to example embodiment 3 a person with Credit Score Class A credit applies for a $2,000 loan. A lender predicts it will earn $10 each quarter on this customer from non-loan revenue if the loan is made. The lender makes this prediction, for example, using data analysis system 701 illustrated in FIG. 7. In one embodiment of the invention a loan application processing unit 723 of a lender system 729 (illustrated in FIG. 7) determines a base return rate to correspond to the predicted quarterly earnings. The base return rate is the amount the Lender expects to earn based solely on the non-loan revenue. This amount is expressed as a percentage of the loan. An initial interest rate is set to equal the base return rate. The initial interest rate is adjustable by the lender system according to the amount over the base return rate the lender aims to earn for the loan.

In one embodiment of the invention the loan interest rate is adjustable by the lender system to take into account pre-payments by the borrower. The pre-payments comprise commissions generated by the borrower's actual purchases made subsequent to the disbursement of the loan proceeds to the borrower. In one embodiment of the invention commission information is provided by POS system 709 to earned commission storage unit 713. A lender is enabled by applicant query module 719 to query information stored in storage unit 713 to determine the value of commissions associated with a borrower.

Table III illustrates an example payment schedule generated by methods and systems of the invention after re-computing a conventionally determined interest rate. The recomputed interest rate in the example is 4.85%. The recomputed interest rate takes into account non loan revenue associated with the borrower.

TABLE III
Loan Amount 2,000

| | | | | | Non- | Total |
|---|---|---|---|---|---|---|
| | Beg | | | Ending | Loan | Lender |
| Qtr | Principal | Payment | Interest | Principal | Revenue | Cash Flow |
| 0 | | | | 2,000.00 | | (2,000.00) |
| 1 | 2,000.00 | (515.25) | 24.25 | 1,509.00 | 10 | 525.25 |
| 2 | 1,509.00 | (515.25) | 18.30 | 1,012.05 | 10 | 525.25 |
| 3 | 1,012.05 | (515.25) | 12.27 | 509.08 | 10 | 525.25 |
| 4 | 509.08 | (515.25) | 6.17 | (0.00) | 10 | 525.25 |
| | | | | | All-in | 8.00% |
| | | | | | Yield | |

FIG. 9 illustrates steps of a method carried out by loan analyzer 111 of lender system 117 as illustrated in FIG. 1 according to an embodiment of the invention. The discussion below is made with reference to an example system illustrated in FIG. 1. The method illustrated in FIG. 9 is one way to generate the recomputed interest rate illustrated in Table 3. At step 902 a loan amount is provided to loan analyzer 111. In one embodiment of the invention borrower 121 inputs a requested loan amount to borrower system 125 via an interactive loan application 123. Borrower system 125 provides data including the requested loan amount to lender system 117. The requested loan amount is provided as an input to loan analyzer 111.

At step 904, lender system 117 communicates with credit information system 127 to obtain credit information associated with borrower 121. In one example embodiment, credit information comprises at least a credit score class determined in accordance with the example schema illustrated in Table 1. In one embodiment of the invention credit information is obtained automatically in response to lender system 117 receiving a request from borrower system 125. In other embodiments of the invention, an operator provides a borrower's credit information to loan analyzer 111.

Unlike conventional lender systems, loan analyzer 111 carries out further steps that account for non loan revenue derived from consumer purchases associated with borrower 121 in determining an interest rate for the loan. One example of non loan revenue is represented in FIG. 1 at 113 as a storage unit storing loan collateral account information associated with borrower 121. The dollar amount in loan collateral account 113 represents non loan revenue. For example, in one embodiment of the invention at least a portion of the amount of loan collateral account 113 corresponds to at least a portion of a commission associated with a sale of a sponsored product, as explained above with reference to FIG. 1.

According to an embodiment of the invention, in order to account for non loan revenue loan analyzer 111 associates an amount in loan collateral account 113 with borrower 121 at step 905. Regardless of how the credit information is provided, at 906 loan analyzer 111 determines an interest rate for the borrower based on the requested loan amount and the credit score information associated with borrower 121. According to one example embodiment of the invention the interest rate is calculated in accordance with Table 1. At 908 loan analyzer 111 determines a repayment schedule for the loan based on the loan amount, the interest rate R and the credit information associated with the borrower.

At 910, analyzer 111 calculates total loan payment revenue based on the repayment schedule determined in step 908. Loan analyzer 111 performs this step, for example, in accordance with the general example provided in Table 2.

At 916, loan analyzer 113 adds non loan revenue (at least a portion of the amount in account 113) to the total loan payments determined in step 910. At 917, loan analyzer 111 determines an “all in yield” based on the total amount determined in step 910. This amount reflects not only revenue from loan payments, but also from the non loan revenue. At step 918, loan analyzer 111 compares the “all in yield” (Y) calculated in step 917 to the interest rate R determined in step 906.

According to step 924 if Y is equal to R the loan is offered to the borrower at an interest rate of R and the method terminates at 928. If Y is not equal to R, loan analyzer 111 proceeds to carry out further steps to determine an interest rate for the loan. In one embodiment of the invention if Y is not equal to R, loan analyzer 111 adjusts R. For example, in step 930 if Y is greater than R, loan analyzer 111 adjusts R downward to arrive at a lower interest rate, adjusted interest rate R. The method continues at step 908 by loan analyzer 111 determining a repayment schedule for the loan, this time using the adjusted R to determine the amount of each payment. Then, steps 910 to 936 are repeated as appropriate until the adjusted R=Y.

According to step 932 if Y is less than R, loan calculator 111 adjusts R upwards to provide a higher interest rate R. The method continues at step 908, this time using the adjusted R. Steps 910 through 936 are repeated as appropriate until Y=R. When Y=R, loan analyzer stops at 928 and provides an interest rate R=Y for the loan. In that manner, systems and methods of the invention enable a borrower to leverage his or her buying power, as reflected in account 113, to obtain a loan at an interest rate that is lower than could be offered using conventional systems and methods. Conventional systems and methods lack apparatus, methods and techniques for capturing and accounting for non loan revenue representing consumer purchases in determining an interest rate for a loan.

### EXAMPLE 4

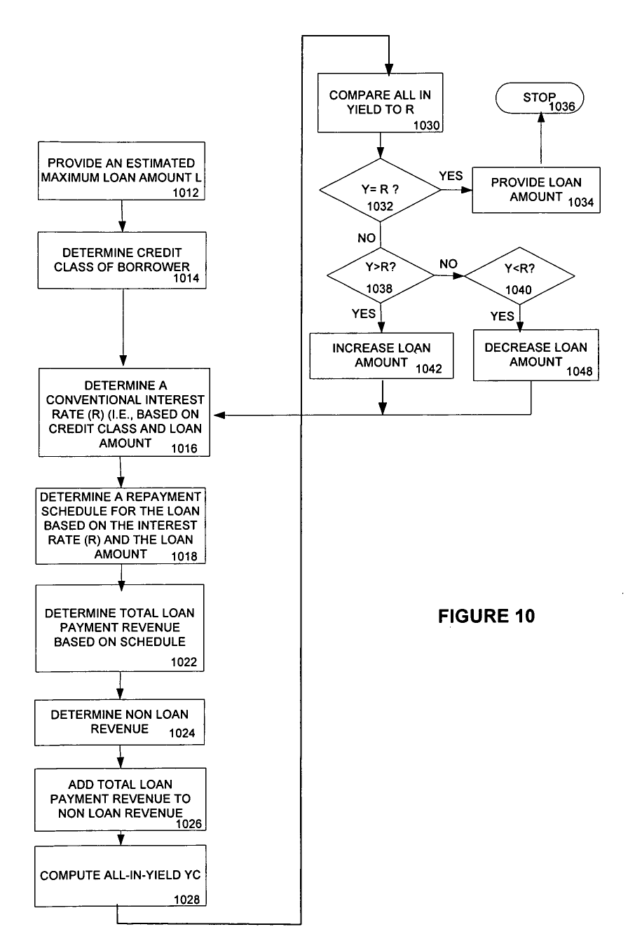

### Table 4 FIG. 10—Increase Loan Amount

In an example scenario represented by Table 4 a borrower with Credit Score Class B credit applies for a loan requesting at least $5,000. Lender predicts it will earn $50 each quarter on this borrower from non-loan revenue associated with this borrower. In one embodiment of the invention this prediction is made using data analysis module 705 of Analyzer 701 (illustrated in FIG. 7). The discussion below is referenced to the example system of FIG. 7. The predicted non loan revenue for this borrower is stored in predicted commission storage account 727 of lender system 729.

In this example scenario, loan term calculator 723 operates in accordance with the method illustrated in FIG. 10 to determine a maximum amount for a loan to be made to the borrower. At step 1012 an initial loan amount, for example the minimum amount requested by the borrower is provided to loan term calculator 723. At step 1014 loan term calculator 723 communicates with credit check agent 721 to obtain credit information associated with the borrower. At step 1016 an interest rate R is calculated for this borrower by traditional methods. That is, an interest rate is calculated based on the minimum loan amount requested in step 1012 and the credit information provided by credit check agent system 721. This is done, for example, by reference to a standard such as illustrated in example Table 1.

At 1018 a loan repayment schedule is determined based on the minimum loan amount and the conventionally chosen interest rate R. At 1022, total loan payment revenue is calculated based on the loan repayment schedule determined at 1018. At step 1024 non loan revenue available to the borrower is determined based on information stored in borrower predicted commission account 727. At step 1026 the total loan payment revenue is added to the non loan revenue available to the borrower to determine total revenue. At step 1028 all in yield Y is determined based on the total revenue determined in the previous step.

At step 1030 Y is compared to R. If Y=R (step 1032) the loan amount determined at step 1012 is the maximum loan amount to be provided to the borrower. If Y is not equal to R, the loan amount is adjusted and the process repeats. For example, if Y>R (step 1038) the loan amount is increased (at 1042) and a conventional interest rate R is computed based on the adjusted loan amount and the credit class of the borrower. A repayment schedule for the loan is determined based on the adjusted interest rate R and the increased loan amount (step 1020). The method proceeds in accordance with steps 1018-1048 until Y=R. The loan amount at which Y=R is the maximum loan amount to be made to the borrower. In that manner, systems and methods of the invention enable a borrower to borrower more money than would be possible using conventional systems and methods.

Table 4 illustrates the scenario of example 4 for a loan amount of $5,170.00 at an initial rate of 10.00%.

TABLE IV

| | | | | | Non- | |
|---|---|---|---|---|---|---|
| | Beg | | | Ending | Loan | Total Lender Cash |
| Quarter | Principal | Payment | Interest | Principal | Revenue | Flow |
| 0 | | | | 5,170.00 | | (5,170.00) |
| 1 | 5,170.00 | (1,374.28) | 129.25 | 3,924.97 | 50 | 1,424.28 |
| 2 | 3,924.97 | (1,374.28) | 98.12 | 2,648.82 | 50 | 1,424.28 |
| 3 | 2,648.82 | (1,374.28) | 66.22 | 1,340.76 | 50 | 1,424.28 |
| 4 | 1,340.76 | (1,374.28) | 33.52 | (0.00) | 50 | 1,424.28 |

| | |
|---|---|
| Interest Rate returned to Lender | 16.00% |

FIG. 10 illustrates steps of a method carried out by loan analyzer 111 of lender system 117 as illustrated in FIG. 1 according to an embodiment of the invention. The method illustrated in FIG. 9 is one way to generate the loan amount illustrated in Table 4. At step 1002 a loan amount is provided to loan analyzer 111. In one embodiment of the invention borrower 121 inputs a requested loan amount to borrower system 125 via an interactive loan application 123. Borrower system 125 provides data including the requested loan amount to lender system 117. The requested loan amount is provided as an input to loan analyzer 111.

At step 1004, lender system 117 obtains credit information associated with borrower 121. In one example embodiment, credit information comprises at least a credit score class determined in accordance with the example schema illustrated in Table 1. In one embodiment of the invention credit information is obtained automatically in response to lender system 117 receiving a request from borrower system 125. In other embodiments of the invention, an operator provides a borrower's credit information to loan analyzer 111. Regardless of how the credit information is provided, at 1006 loan analyzer 111 determines a loan amount for the borrower based on the requested interest rate and the credit score information associated with borrower 121. According to one example embodiment of the invention the loan amount is calculated in accordance with Table 1.

At 1008 loan analyzer 111 determines a repayment schedule for the loan based on the loan amount, the interest rate R and the credit information associated with the borrower. At 1010, analyzer 111 calculates total loan payment revenue based on the repayment schedule determined in step 908. Loan analyzer 111 performs this step, for example, in accordance with the general example provided in Table 2.

Unlike conventional lender systems, loan analyzer 111 carries out further steps that account for non loan revenue derived from consumer purchases associated with borrower 121 in determining a loan amount. One example of non loan revenue is represented in FIG. 1 at 113 as a storage unit storing loan collateral account information associated with borrower 121. The dollar amount in loan collateral account 113 represents non loan revenue. For example, in one embodiment of the invention at least a portion of the amount of loan collateral account 113 corresponds to at least a portion of a commission associated with a sale of a sponsored product, as explained above with reference to FIG. 1.

According to an embodiment of the invention, in order to account for non loan revenue loan analyzer 111 associates an amount in loan collateral account 113 with borrower 121 at step 1016. At 1018, loan analyzer 111 adds this non loan revenue (at least a portion of the amount in account 113) to the total loan payments determined in step 1008. At 1020, loan analyzer 111 determines an “all in yield” based, not only on the loan payments, but also on the non loan revenue. At step 1022, loan analyzer 111 compares the “all in yield” (Y) calculated in step 1020 to the interest rate R requested by the borrower in step 1006.

According to step 1024 if Y is equal to R the loan amount L is provided to the borrower at an interest rate requested and the method terminates at 1028. If Y is not equal to R, loan analyzer 111 proceeds to carry out further steps to determine a loan amount. In one embodiment of the invention if Y is not equal to R, loan analyzer 111 adjusts L to L′. For example, in step 930 if Y is greater than R, loan analyzer 111 adjusts L upward to arrive at a greater loan amount L′. The method continues at step 1012 by loan analyzer 111 re-calculating the loan payments, this time in accordance with loan amount L′. Then, steps 1014 to 1036 are repeated until R′=Y.

According to step 1032 if Y is less than R, loan calculator 111 adjusts L downwards to provide a lower loan amount L′. The method resumes at step 1012. Steps 1014 through 1036 are repeated until Y=R. When Y=R, loan analyzer stops at 1028 and provides a loan amount of L′ at interest rate R. In that manner, systems and methods of the invention enable a borrower to leverage his or her buying power, as reflected in account 113, to obtain a loan for an amount that is greater than the amount he or she could have been offered using conventional systems and methods. Conventional systems and methods lack apparatus, methods and techniques for capturing and accounting for non loan revenue representing consumer purchases in determining a loan amount for a loan.

### EXAMPLE 5

### Table 5, FIG. 8—Non Loan Revenue Reduces Rate on Existing Loan

According to one embodiment of the invention a borrower is enabled by systems and methods of the invention to reduce interest rate on an existing loan based on consumers purchases associated with the borrower after the existing loan was made. For example, borrower in Example 1 buys a sponsored product at a seller system 135 (illustrated in FIG. 1) via point of sale unit 139 in the 1st Quarter of the borrower's loan repayment schedule. In the case in which the product is a sponsored product for which the sponsor has allocated a commission of $30, the commission information is provided to sponsor system 103. Sponsor system 103 provides at least a portion of the $30.00 commission to loan collateral account 113.

For example, Lender system 117 reserves $10 of the $30.00 commission to the borrower and records the $10.00 in loan collateral account 113. Loan analyzer 111 then re-computes the interest rate for the borrower according to the method illustrated in FIG. 8. A loan is made to a borrower at an interest rate. The loan repayment period commences according to a repayment schedule as illustrated in step 801. After the loan repayment term commences lender system 117 (illustrated in FIG. 1) receives a request from a borrower system whereby the borrower requests rewards comprising non loan revenue to be applied to her existing loan to reduce the interest rate on her existing loan.

At step 805 loan analyzer 111 communicates with loan collateral account 113 associated with this borrower to determine an amount of non loan revenue to be applied. Loan analyzer 111 further determines the principal balance on the loan at the time of the request. Loan analyzer 111 then subtracts the non loan revenue determined in step 805 from the principal balance computed in step 807 to arrive at an adjusted principle balance at step 809. Loan analyzer 111 then determines a new payment schedule based on the adjusted principal balance and the present interest rate R on the existing loan at step 811. At 813 loan analyzer 111 calculates all in yield Y based on the payment schedule determined in step 811.

At step 815 Y is compared to R. If Y=R the new payment schedule is generated based on R. If Y does not equal R, R is adjusted. For example if Y is greater than R at step 830, R is reduced at step 834. The method continues at step 811 by loan analyzer 111 determining a new payment schedule based on the reduced R. Steps 813 through 836 are repeated, as appropriate, until adjusted R=Y.

If Y is less than R at step 832, R is increased. The method continues at step 811 by loan analyzer 111 determining a new payment schedule based on the increased R. Steps 813 through 836 are repeated, as appropriate, until adjusted R=Y.

Table V illustrates an example of adjusted interest rate for a borrower in credit class B with an existing loan of 2000.00. The borrower has rewards in her loan collateral account in an amount of $10.00. Her request to apply the reward to her loan is received by lender system 117 after her first payment but before her second payment. Loan analyzer 111 provides a new payment schedule with adjusted payment amounts reflecting a reduced interest rate of 5.65%.

TABLE V

| | Beg | | | Ending | Reward | Assumed | New | New Rate |
|---|---|---|---|---|---|---|---|---|
| QTR [symbol] | Principal | Payment | Interest | Principal | Value | Principal | Payment | Calculation |
| 0 | | | | 2,000.00 | | | | |
| 1 | 2,000.00 | (522.06) | 35.00 | 1,512.94 | 10 | 1,502.94 | ($518.61) | 1,512.94 |
| 2 | 1,512.94 | (522.06) | 26.48 | 1,017.35 | | | | (518.61) |
| 3 | 1,017.35 | (522.06) | 17.80 | 513.09 | | | | (518.61) |
| 4 | 513.09 | (522.06) | 8.98 | 0.00 | | | | (518.61) |

[symbol]

indicates data missing or illegible when filed

### EXAMPLE 6

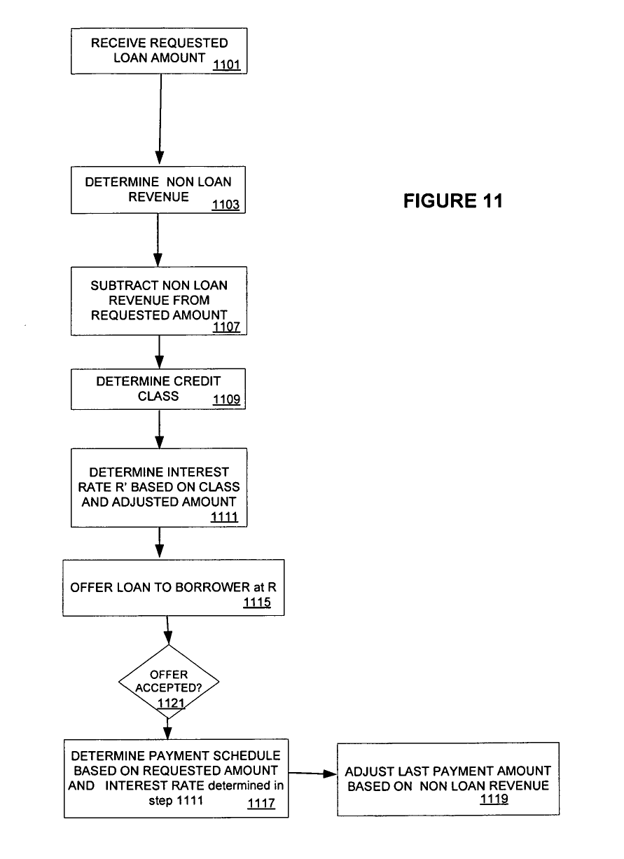

### Table 6, FIG. 11—Using Actual Current Non Loan Revenue to Reduce Rate on New Loan by Applying Non Loan as Collateral—Reducing Principal

In another example a borrower with Credit Score Class C would like to borrow 5,000 at the lowest interest rate he qualifies for. Assume this borrower has earned rewards, for example, by purchasing sponsored products prior to making his loan application. A value is associated with the borrower's rewards. The value is allocated to loan collateral account 113 of lender system 117 as illustrated in FIG. 1. FIG. 11 illustrates steps of a method according to an embodiment of the invention that will determine the lowest interest rate that can be provided to this borrower considering not only the amount of the loan and the borrower's credit rating, but also accounting for the rewards the borrower has earned through his consumer purchases.

At step 1101 a lender system 117 communicates with a borrower system 125. Lender system 117 receives a loan request from the borrower for a loan amount. At step 1103 loan analyzer 111 communicates with loan collateral unit 113 to determine the dollar value (non loan revenue) associated with the rewards earned by the borrower, for example, by the borrower's consumer purchases made via seller system 133. At step 1107 this non loan revenue is subtracted from the requested loan amount. At step 1109 lender system 117 communicates with credit information system 127 to determine a credit class for this borrower.

At step 1111 an interest rate for the borrower is determined based upon the credit class and the adjusted loan amount. Since the adjusted loan amount is lower than the requested loan amount the interest rate determined in step 1111 is likely to be lower than an interest rate determined based on the requested amount. In that case, a loan may be offered to the borrower at the lower interest rate at step 1115. In one embodiment of the invention, if the borrower accepts the offer, loan analyzer 111 then determines a payment schedule for the borrower based on the lower interest rate at step 1117. In one embodiment of the invention, loan analyzer 111 adjusts the final payment of the loan at step 1119 by an amount based on the non loan revenue determined in step 1105.

Table VI illustrates an example payment schedule for a borrower who has $520 of rewards value. The method results in a reduction of interest rate for a $5,000 loan to the C class borrower from 30% to 10%.

TABLE VI

| | Beg | | | Ending | Use | Total Borrower Cash |
|---|---|---|---|---|---|---|
| QTR | Principal | Payment | Interest | Principal | of Reward | Flow |
| 0 | | | | 5,000.00 | | 5,000.00 |
| 1 | 5,000.00 | (1,454.27) | 317.09 | 3,862.82 | 0 | (1,454.27) |
| 2 | 3,862.82 | (1,454.27) | 244.97 | 2,653.53 | 0 | (1,454.27) |
| 3 | 2,653.53 | (1,454.27) | 168.28 | 1,367.54 | 0 | (1,454.27) |
| 4 | 1,367.54 | (1,454.27) | 86.73 | 0.00 | 519.7 | (934.57) |

Thus while the invention has been shown and described with respect to particular embodiments, it is not limited to these embodiments. Numerous modifications, changes and enhancements will now be apparent to the reader having read the disclosure of the embodiments of the invention provided herein.

What is claimed is:

1. A method for providing a loan to a borrower comprising steps of:
receiving a loan request from said borrower;
automatically determining non loan revenue associated with said borrower in response to receiving said loan request;
automatically calculating at least one term for said loan based, at least in part, upon said non loan revenue.

2. The method of claim 1 wherein the step of automatically determining non loan revenue associated with said borrower is carried out by steps of:
analyzing stored information related to past purchases associated with said borrower;
predicting an amount of said non loan revenue to be associated with said borrower in the future based, at least in part, on said analysis;
calculating said at least one loan term based, at least in part on said predicted non loan revenue.

3. The method of claim 1 wherein the step of determining non loan revenue is carried out by automatically analyzing stored information related to past purchases made by at least one purchaser representative of said borrower.

4. The method of claim 1 wherein said non loan revenue is selected from the group comprising: commissions on sales of sponsored merchandise and advertising revenue.

5. The method of claim 1 further including a step of automatically disbursing proceeds of said loan to said borrower.

6. The method of claim 1 wherein said at least one loan term comprises interest rate, the method further including steps of:
calculating a first interest rate based on a credit score associated with said borrower;
determining a first loan repayment schedule based on said first interest rate;
determining an all-in-yield based on said first loan repayment schedule;
determining an amount of non loan revenue to be associated with said borrower,
adding said non loan revenue to said all-in-yield to obtain an adjusted all-in-yield;
calculating a second interest rate based upon said adjusted all-in-yield;
determining a second loan repayment schedule based on the second interest rate.

7. The method of claim 1 wherein said at least one loan term comprises amount loaned, the method further including steps of:
obtaining credit information associated with said borrower in response to receiving said loan request;
calculating a maximum loan amount and an interest rate for said loan based at least in part upon said credit information;
determining a re-payment schedule for said loan based upon said maximum loan amount and said interest rate;
calculating a first all in yield based on said re-payment schedule;
adding said non loan revenue to said first all in yield to obtain a second all in yield;
increasing said maximum loan amount such that said second all in yield equals said first all in yield;
said adjusted maximum loan amount comprising a loan term for said borrower.

8. A method of providing a rewards program comprising steps of:
enrolling at least one borrower in said program;
analyzing data related to sales and advertising revenue associated with said borrower;
awarding points to said borrower based upon said analysis;
determining loan terms for said borrower based upon said awarded points.

9. The method of claim 9 wherein the step of determining loan terms is carried out by a step of determining at least one of an interest rate, a loan amount and loan repayment terms for said loan based upon said awarded points.

10. The method of claim 1 wherein the step of calculating said at least one loan term is carried out including steps of:
determining a credit score for said borrower;
determining a first interest rate for said loan based at least in part on said credit score;
allocating points to said borrower based on said non loan revenue;
adjusting said first interest rate based upon said non loan revenue to obtain a second interest rate;
said second interest rate comprising said at least one loan term.

11. A method for providing a loan to a borrower comprising steps of:
receiving a loan request from said borrower;
providing a loan including loan terms to said borrower in response to said request;
receiving a request from said borrower to adjust said loan terms after making said loan to said borrower;
automatically determining non loan revenue associated with said borrower in response to receiving said loan adjustment request;
automatically re-calculating at least one term for said loan based, at least in part, upon said non loan revenue.

12. A system for providing a loan to a borrower comprising:
a loan application receiving module configured to receive loan application information related to a borrower;
a data analyzer coupled to a source of sales and advertising data, said analyzer configured to determine an amount of non loan revenue to be associated with said borrower based upon said information related to said borrower and upon analysis of said sales and advertising data;
a loan term calculator coupled to said data analyzer and including an input for receiving said amount of non loan revenue to be associated with said borrower;
said loan term calculator determining at least one loan term of said loan based at least in part on said non loan revenue associated with said borrower.

13. The system of claim 12 further comprising a borrower system configured for communication with said loan application receiving module, said borrower system comprising:
at least one input device enabling a borrower to input information comprising a loan application;
a cash dispensing apparatus configured to dispense cash comprising loan proceeds to said borrower in accordance with said at least one loan term.

14. The system of claim 12 further comprising:
a memory;
at least one point of sale system coupled to said memory to provide information related to sales of products to consumers for storage in said memory;
at least one advertising impression collecting system coupled to said memory to provide information related to response to advertisements for storage in said memory, said memory thereby comprising;
said memory thereby comprising said source of sales and advertising data.

15. The system of claim 12 wherein said loan term calculator includes an interest rate calculator configured to calculate a loan term comprising an interest rate for said loan based, at least in part, on said non loan revenue associated with said borrower.

16. The system of claim 12 wherein said loan term calculator includes a loan amount calculator configured to determine a loan amount for said loan based, at least in part upon said non loan revenue associated with said borrower.

17. The system of claim 12 wherein said loan term calculator includes a loan repayment schedule calculator configured to provide a loan repayment schedule based, at least in part upon said non loan revenue associated with said borrower.
